(19) United States
(12) Patent Application Publication
(10) Pub. No.: US 2015/0354255 A1
(43) Pub. Date: Dec. 10, 2015

(54) LOCK ARRANGEMENT FOR A MOTOR VEHICLE

(71) Applicant: BROSE SCHLIESSSYSTEME GMBH & CO. KG, Wuppertal (DE)

(72) Inventors: Michael Wittelsbuerger, Lake Orion, MI (US); David Rosales, Rochester Hills, MI (US); Stepan Hanke, Lake Orion, MI (US)

(21) Appl. No.: 14/554,644

(22) Filed: Nov. 26, 2014

Related U.S. Application Data
(60) Provisional application No. 62/008,922, filed on Jun. 6, 2014.

(51) Int. Cl. E05C 3/16

(52) U.S. Cl. CPC E05C 3/162

(57) ABSTRACT

Embodiments of the invention are directed at a lock arrangement for a motor vehicle, the lock arrangement comprising an actuating arrangement, a movable arrangement and a Bowden cable arrangement with a cable strand and a cable conduit, wherein the actuating arrangement is coupled to the movable arrangement via the Bowden cable arrangement such that an actuation of the actuating arrangement causes a movement of the movable arrangement through a relative movement of the cable strand and the cable conduit. The lock arrangement is characterized in that, the lock arrangement comprises a double action arrangement arranged at at least one end of the Bowden cable arrangement, wherein the cable strand and the cable conduit are coupled to the double action arrangement such that the double action arrangement causes both a movement of the cable strand and a movement of the cable conduit on actuation of the actuating arrangement.

### CROSS-REFERENCES TO RELATED APPLICATIONS

This application claims the benefit of U.S. Provisional Application No. 62/008,922 filed Jun. 6, 2014, the content of which is hereby incorporated herein by reference in its entirety.

### FIELD OF THE INVENTION

The invention is directed to a lock arrangement for a motor vehicle.

### BACKGROUND

From the prior art and in particular from DE 10 220 732 A1 it is known to use a Bowden cable arrangement to transmit an actuating movement to a vehicle lock, for example for deflecting the vehicle lock's pawl out of its engagement position with the vehicle lock's catch. In such a lock arrangement for a motor vehicle with a Bowden cable arrangement, the actuating movement is transformed into a relative movement of a cable strand of the Bowden cable, which cable strand forms the inner part of the Bowden cable, and a cable conduit, also called a sheath, of the Bowden cable, which cable conduit forms the outer part of the Bowden cable. In the prior art, the cable strand is coupled to the respective moving part both of the actuating arrangement and the movable arrangement to which the actuation is to be transmitted. The cable conduit, on the other hand, is coupled at both ends with a cable abutment, which cable abutment is fixedly coupled with the respective housing of the actuating arrangement or the movable arrangement.

The lock arrangement known from the prior art requires a relatively large packaging in order to provide either a sufficient travel for the relative movement between the cable strand and the cable conduit or a sufficient force or torque associated with this relative movement. This is because such travel, force or torque can be increased by making the length of the lever coupled to the movable part of the Bowden cable arrangement—generally the cable strand—larger, which generally directly translates into a larger packaging size. This situation exists in principle both for the actuating arrangement and the movable arrangement.

Therefore it is an object of the invention to improve the known design of a lock arrangement for a motor vehicle lock with a Bowden cable arrangement such that smaller packaging is made possible without compromising performance.

### SUMMARY

Embodiments of the invention solve the above noted object for a motor vehicle lock.

The basic idea underlying the invention is to translate the actuating movement into a movement both of the cable strand and of the cable conduit of the Bowden cable arrangement by means of a double action arrangement. Thus, rather than having only one of the transmitting components of Bowden cable arrangement moving and the other fixed, both the cable conduit and the cable strand are moved. This enables the use of shorter levers for the respective movement of the cable strand and the cable conduit and permits the realization of desired lever gear ratios to meet specific requirements. Moreover, by having both transmitting components of the Bowden cable arrangement movable, the need for space for fixing cable abutment is obviated. Finally, such a movement of both the cable strand and the cable conduit results in a crunch effect to break any potential ice blocking the Bowden cable arrangement.

In principle, such a double action arrangement can be equally employed at either end of the Bowden cable arrangement transparently. That is, the respective other side of the Bowden cable arrangement is not affected by having the double action arrangement on one side. According to an embodiment, there is a respective double action arrangement at both ends of the Bowden cable arrangement.

An embodiment provides a double action arrangement within a motor vehicle lock and in particular for moving a pawl actuating lever of the motor vehicle lock for deflecting a pawl.

An embodiment provides an implementation of such a double action arrangement in which there are two pivotable double action levers, of which one is coupled with the cable strand and the other is coupled with the cable conduit of the Bowden cable arrangement.

In an embodiment, the double action levers can be mutually coupled such that any pivoting movement of either double action lever causes a proportional pivot movement of the respective other double action lever.

This permits, in an embodiment, predefining a pivoting ratio between the double action levers, which pivoting ration corresponds to a gear ratio between the double action levers.

Such a mutual coupling can in particular be effected by having the double action levers comprise a respective cable arm for the respective connection to the cable strand or the cable conduit and a respective link arm for their mutual coupling.

According to an embodiment, a specific pivoting ratio and thereby also a gear ratio may be defined by the ratio of the respective length of the link arms.

Finally, in an embodiment, a gear ratio may be used for a double action arrangement on the side of the door actuation lever in order to reduce the required mass of a crash counter mass body comprised by a corresponding door actuating arrangement.

In an embodiment, the invention provides a lock arrangement for a motor vehicle, such as a lock arrangement for a motor vehicle door, the lock arrangement comprising an actuating arrangement, a movable arrangement and a Bowden cable arrangement with a cable strand and a cable conduit, wherein the actuating arrangement is coupled to the movable arrangement via the Bowden cable arrangement such that an actuation of the actuating arrangement causes a movement of the movable arrangement through a relative movement of the cable strand and the cable conduit, wherein the lock arrangement comprises a double action arrangement arranged at at least one end of the Bowden cable arrangement, wherein the cable strand and the cable conduit are coupled to the double action arrangement such that the double action arrangement causes both a movement of the cable strand and a movement of the cable conduit on actuation of the actuating arrangement.

In an embodiment, the lock arrangement comprises a respective double action arrangement at both ends of the Bowden cable arrangement.

In an embodiment, the movable arrangement is arranged within a motor vehicle lock, such as the double action arrangement is arranged within the motor vehicle lock.

In an embodiment, the movable arrangement comprises a pawl actuation lever for deflecting a pawl of the motor vehicle lock, such as the pawl actuation lever is configured to pivot around an actuation lever axis for deflecting the pawl of the motor vehicle lock.

In an embodiment, the actuating arrangement comprises a door actuating lever of a door handle of the motor vehicle.

In an embodiment, the double action arrangement comprises two pivotable double action levers, wherein a first double action lever is a cable strand lever coupled to the cable strand and a second double action lever is a cable conduit lever coupled to the cable conduit.

In an embodiment, the double action levers are pivotable around a respective double action lever axis, such as the double action lever axes of the double action levers define a line which is substantially parallel to a direction of relative movement between a respective coupling point of the cable strand and the cable conduit with the double action arrangement.

In an embodiment, the double action levers are mutually coupled such that a pivoting movement of either double action lever causes a proportional pivoting movement of the respective other double action lever in the opposite pivoting direction.

In an embodiment, the double action levers are mutually coupled such that the relative movement between the cable strand and the cable conduit results in a predefined pivoting ratio between the double action levers.

In an embodiment, the double action levers are multi-armed, such as two-armed, levers comprising a respective cable arm, wherein the cable arm of the cable strand lever is coupled to the cable strand and the cable arm of the cable conduit lever is coupled to the cable conduit.

In an embodiment, the cable arms of the double action levers have substantially the same length, such as with respect to their respective double action lever axis.

In an embodiment, the double action levers comprise a respective link arm, wherein the link arms of the double action levers are mutually coupled, such as wherein the links arms of the double action levers are mutually coupled so as to cause the proportional pivoting movement of the respective other double action lever in the opposite pivoting direction.

In an embodiment, the link arms of the double action levers are of a respectively different length, such as with respect to their respective double action lever axis, so as to predefine the pivoting ratio between the double action levers.

In an embodiment, the lock arrangement comprises a crash counter mass body for preventing the relative movement of the cable strand and the cable conduit in the case of a crash, which crash counter mass body is fixedly coupled with a crash mass lever of the double action levers.

In an embodiment, the actuating arrangement comprises a manual actuating lever fixedly connected to the double action lever distinct from the crash mass lever.

### BRIEF DESCRIPTION OF THE FIGURES

Some embodiments will hereinafter be described in conjunction with the appended drawings, in which

FIG. 1 shows a schematic view of a motor vehicle door with a proposed lock arrangement comprising a motor vehicle lock and a door handle of the motor vehicle;

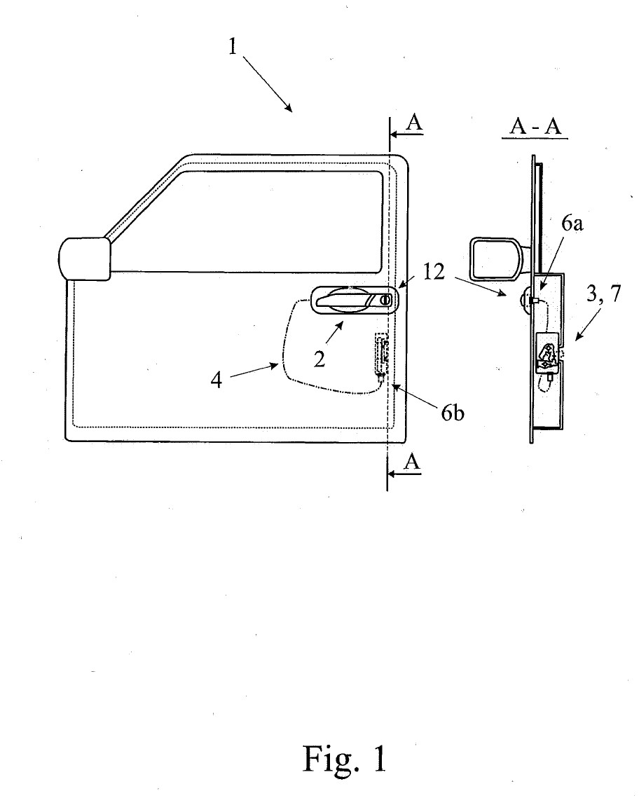

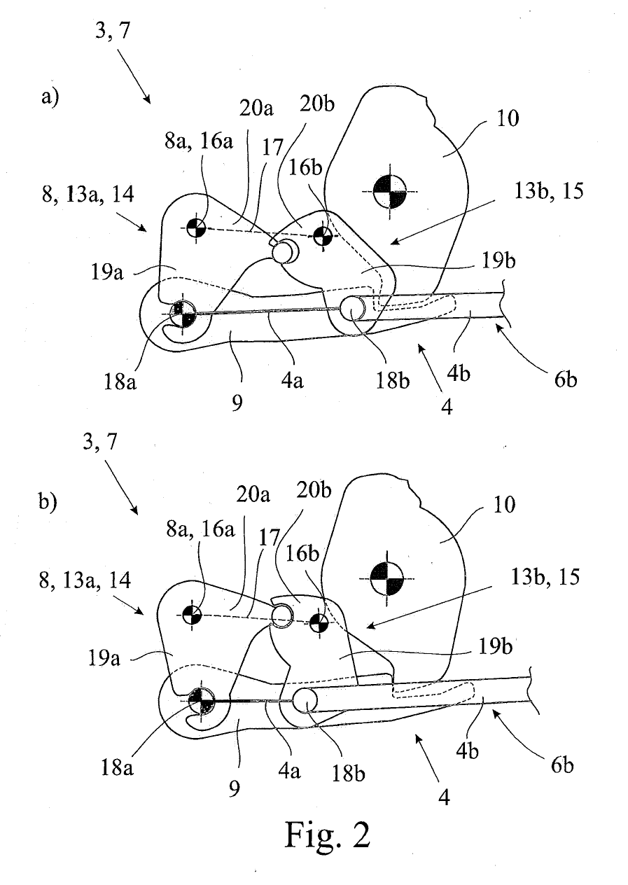

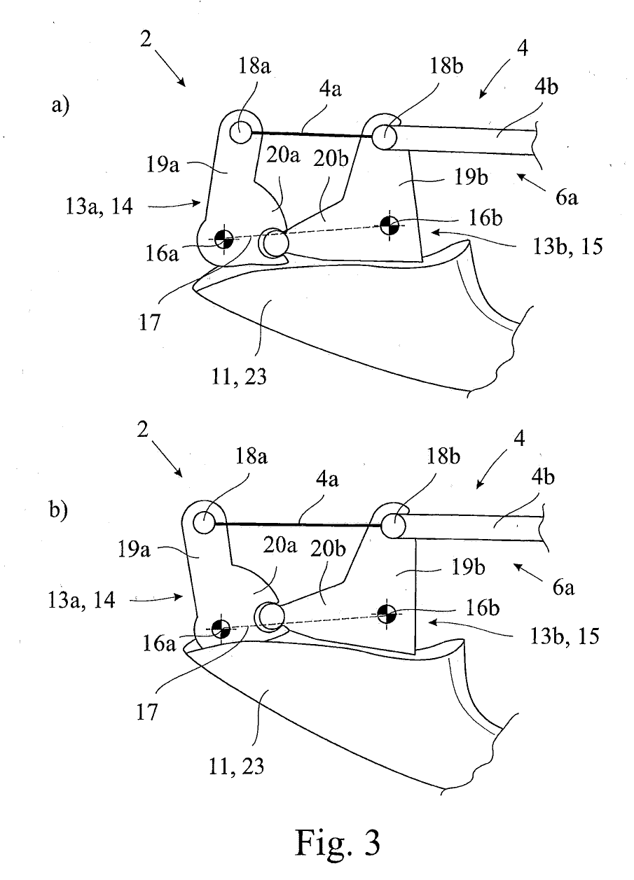

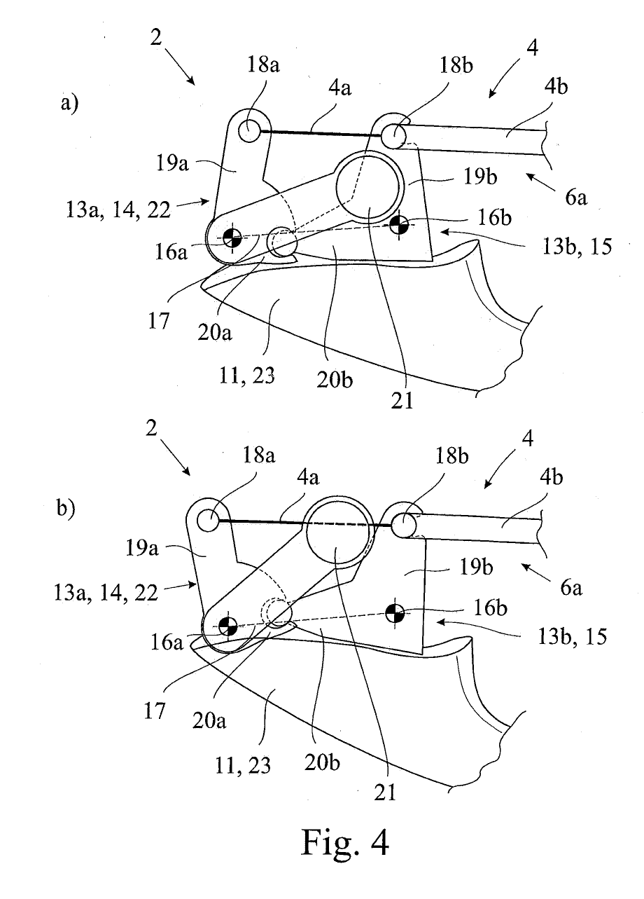

FIG. 2 shows a schematic view of the double action arrangement at the side of the movable arrangement of the lock arrangement of FIG. 1 within the motor vehicle lock
a) in a state prior to actuation, and
b) in a state after actuation;

FIG. 3 shows a schematic view of the double action arrangement at the side of the of actuating arrangement of the lock arrangement of FIG. 1 at a door handle side of the motor vehicle
a) in a state prior to actuation, and
b) in a state after actuation; and

FIG. 4 shows a schematic view of an alternative embodiment of the double action arrangement of FIG. 3 with a crash mass
a) in a state prior to actuation, and
b) in a state after actuation.

### DETAILED DESCRIPTION

The lock arrangement shown in the drawings and in particular in FIG. 1 is assigned to a motor vehicle and in particular to a motor vehicle door 1 of the motor vehicle. The lock arrangement comprises an actuating arrangement 2, a movable arrangement 3 and a Bowden cable arrangement 4 with a cable strand 4a and a cable conduit 4b. In the proposed lock arrangement, the actuating arrangement 2 is coupled to the movable arrangement 3 via the Bowden cable arrangement 4 such that an actuation of the actuating arrangement 2 causes a movement of the movable arrangement 3 through a relative movement of the cable strand 4a and the cable conduit 4b.

The proposed lock arrangement is characterized in that the lock arrangement comprises a double action arrangement 5 arranged at at least one end 6a, b of the Bowden cable arrangement 4, wherein the cable strand 4a and the cable conduit 4b are coupled to the double action arrangement 5 such that the double action arrangement 5 causes both a movement of the cable strand 4a and a movement of the cable conduit 4b on actuation of the actuating arrangement 2. Since in principle the double action arrangement 5 may be arranged at either end 6a, b of the Bowden cable arrangement 4 it follows that the double action arrangement 5 may be equally arranged at the end 6a of the Bowden cable arrangement 4 corresponding to the actuating arrangement 2 or at the end 6b of the Bowden cable arrangement 4 corresponding to the movable arrangement 3.

Though there may also be only a single double action arrangement 5, the lock arrangement can comprises a respective double action arrangement 5 at both ends 6a, b of the Bowden cable arrangement 4. Thereby the reduction in packaging can be realized at the end 6a of the Bowden cable arrangement 4 corresponding to the actuating arrangement 2 and also at the end 6b of the Bowden cable arrangement 4 corresponding to the movable arrangement 3.

In an embodiment, the movable arrangement 3 is arranged within a motor vehicle lock 7. In particular the double action arrangement 5 is arranged within the motor vehicle lock 7. The movable arrangement 3 and/or the double action arrangement 5 may therefore also be arranged in a—here not shown—lock housing of the motor vehicle lock 7.

In an embodiment, the movable arrangement 3 comprises a pawl actuation lever 8 for deflecting a pawl of the motor vehicle lock 7. This deflection of the pawl may also be effected indirectly, as is in particular the case for the arrangement shown in FIG. 2. Here, the pawl actuation lever 8 is pivotably coupled to a deflection lever 9. The deflection lever 9 in turn deflects a pawl lever 10, which is fixedly coupled to the pawl proper, which is not shown here.

The motor vehicle lock 7 further comprises a catch for engaging a striker of the motor vehicle, with which catch the pawl may be brought into a blocking engagement. Neither catch nor striker are shown in the figures. The motor vehicle lock 7 may further comprise other components of such a motor vehicle lock.

The pawl actuation lever 8 can be configured to pivot around an actuation lever axis 8a for deflecting the pawl of the motor vehicle lock 7. As shown in FIG. 2, the pawl actuation lever 8 may be directly coupled to the Bowden cable arrangement 4 and in particular with the Bowden cable strand 4a. Alternatively, there may be an indirect coupling between the Bowden cable arrangement 4 and the pawl actuation lever 8, e.g. through a system of levers of the movable arrangement 3.

As shown in FIGS. 3 and 4, the actuating arrangement 2 comprises a door actuating lever 11 of a door handle 12 of the motor vehicle.

Referring now to FIGS. 2, 3 and 4, the double action arrangement 5 comprises two pivotable double action levers 13a, b, wherein a first double action lever 13a is a cable strand lever 14 coupled to the cable strand 4a and the second double action lever 13b is a cable conduit lever 15 coupled to the cable conduit 4b. In an embodiment, the double action levers 13a, b are pivotable around a respective double action lever axis 16a, b—as shown in FIGS. 2, 3 and 4. Such a double action lever axis 16a may be identical to the actuation lever axis 8a of the pawl actuation lever 8 of FIG. 2. In an embodiment, the double action lever axes 16a, b of the double action levers 13a, b define a line 17 which is substantially parallel to a direction of relative movement between a respective coupling points 18a, b of the cable strand 4a and the cable conduit 4b with the double action arrangement 5.

As is also shown in FIGS. 2, 3 and 4, the double action levers 13a, b are mutually coupled such that a pivoting movement of either double action lever 13a, b, causes a proportional pivoting movement of the respective other double action lever 13a, b in the opposite pivoting direction. Thereby the cable strand 4a and the cable conduit 4b are both linearly moved in respective opposite directions through the double action arrangement 5.

In an embodiment, the double action levers 13a, b are mutually coupled such that the relative movement between the cable strand 4a and the cable conduit 4b results in a predefined pivoting ratio between the double action levers 13a, b. According to a first option, the pivoting movement of one double action lever 13a, b may cause an equal pivoting movement—in terms of degree of rotation—of the respective other double action 13a, b in the opposite pivoting direction. Alternatively, this predefined pivoting ratio may in particular be unequal to unity, thereby providing a mechanical advantage corresponding to a gear ratio between the double action levers 13a, b. In this case the relative movement between the cable strand 4a and the cable conduit 4b is not equally split in half between the cable strand 4a and the cable conduit 4b, i.e. the travel distance of the cable strand 4a is unequal to the travel distance of the cable conduit 4b. The sum of the travel distance of the cable strand 4a and of the travel distance of the cable conduit 4b corresponds to the total travel distance of the Bowden cable arrangement 4.

In an embodiment, the double action levers 13a, b are multi-armed and in particular—as shown in FIGS. 2, 3 and 4—two-armed levers comprising a respective cable arm 19a, b, wherein the cable arm 19a, b of the cable strand lever 14 is coupled to the cable strand 4a and the cable arm 19b of the cable conduit lever 15 is coupled to the cable conduit 4b. In an embodiment, the cable arms 19a, b of the double action levers 13a, b have substantially the same length, in particular, with respect to their respective double action lever axis 16a, b. In this way, a compact packaging can be achieved because the area defined by the coupling points 18a, b and the double action lever axes 16a, b is minimized

In an embodiment, the double action levers 13a, b comprise a respective link arm 20a, b wherein the link arms 20a, b of the double action levers 13a, b are mutually coupled. This can be seen in FIGS. 2, 3 and 4. In particular, the link arms 20a, b of the double action levers 13a, b are mutually coupled so as to cause the proportional pivoting movement of the respective other double action lever 13a, b in the opposite pivoting direction. As shown in FIGS. 2, 3 and 4, the link arms 20a, b may be of a respectively different length, in particular with respect to their respective double action lever axis 16a, b, so as to predefine the pivoting ratio between the double action levers 13a, b. The gear ratio between the double action levers 13a, b in the above-discussed sense may then be substantially defined by the ratio of the lengths of the respective link arms 20a, b.

Referring to the motor vehicle lock 7 shown schematically in FIG. 2, this mutual coupling combined with the gear ratio defined by the different lengths of the link arms 20a permits the exertion of a greater torque on the pawl actuation lever 8 by means of the Bowden cable arrangement 4 than would be possible if a conventional Bowden cable arrangement were used with the same packaging. In effect, rather than coupling the cable strand 4a with the pawl actuation lever 8 further from the double action lever axis 16a, which would increase torque through a greater lever arm but require space in a direction orthogonal to the direction of the relative movement of the cable strand 4a and the cable conduit 4, the double action arrangement 5 acts to provide a mechanical advantage.

Such a double action arrangement 5 substantially extends in a direction parallel to the direction of the relative movement of the cable strand 4a and the cable conduit 4b. Thus, the double action arrangement 5 can be provided for without substantially increasing packaging. Apart from the packaging issues, it is also to be noted that a longer pawl actuation lever 8 is also more exposed, for example with regard to an outside impact in case of a crash situation.

Packaging is also saved for the situations shown in FIGS. 3 and 4, i.e. when the double action arrangement 5 is arranged at the end 6b of the Bowden cable arrangement 4 corresponding to the actuating arrangement 2. Specifically, at a door handle 12 the actuating arrangement 2 comprises a door actuating lever 11 fixedly coupled with the cable conduit lever 15. Without the double action arrangement 5 disclosed in FIGS. 3 and 4, e.g. with a fixed cable conduit 4b and a direct coupling of the cable strand 4a with an actuating lever fixedly coupled to the door actuating lever 11, that actuating lever would need to be longer than the respective length of the cable arms 19a, b of the double action levers 13a, b to achieve the same travel distance as with the double action arrangement 5. Thereby, packaging space is saved while achieving the same travel distance.

In particular with regard to FIG. 4, the lock arrangement comprises a crash counter mass body 21 for preventing the relative movement of the cable strand 4a and the cable conduit 4b in the case of a crash. The crash counter mass body 21 is fixedly coupled with a crash mass lever 22 of the double action levers 13a, b. In other words, the specific double action lever 13a, b with which the crash counter mass body 21 is fixedly coupled is designated as crash mass lever 22. In an embodiment, the actuating arrangement 2 comprises an manual actuating lever 23, which in this case is the door actuating lever 11 fixedly connected to the double action lever 13b distinct from the crash mass lever 20. Since the door actuating lever 11 is here only directly coupled with the double action lever 13b, the other double action lever 13a—which here is the crash mass lever 22—is only driven via the coupling of the link arms 20a, b.

In the case of a crash and due to the associated acceleration, the crash mass lever 22 moves correspondingly and in the same direction as the door actuating lever 11. Thereby, relative movement between the cable strand 4a and the cable conduit 4b is eliminated and no actuation is seen on the side of the movable arrangement 3. Consequently, an inadvertent movement of e.g. the pawl actuation lever 8 is averted.

Because of the gear ratio corresponding to the predefined pivoting ratio between the double action levers 13a, b and substantially defined by the length ratio of the link arms 20a, b, the effective crash counter mass of the crash counter may body 22 “seen” by the door actuating lever 11 is increased by that gear ratio. In other words, the effectiveness of the crash counter mass is increased by that ratio and consequently, a smaller crash counter mass body 21 can be employed.

1. A lock arrangement for a motor vehicle, the lock arrangement comprising an actuating arrangement, a movable arrangement and a Bowden cable arrangement with a cable strand and a cable conduit, wherein the actuating arrangement is coupled to the movable arrangement via the Bowden cable arrangement such that an actuation of the actuating arrangement causes a movement of the movable arrangement through a relative movement of the cable strand and the cable conduit,
wherein the lock arrangement comprises a double action arrangement arranged at to at least one end of the Bowden cable arrangement, wherein the cable strand and the cable conduit are coupled to the double action arrangement such that the double action arrangement causes both a movement of the cable strand and a movement of the cable conduit on actuation of the actuating arrangement.

2. The lock arrangement according to claim 1, wherein the lock arrangement comprises a respective double action arrangement at both ends of the Bowden cable arrangement.

3. The lock arrangement according to claim 1, wherein the movable arrangement is arranged within a motor vehicle lock.

4. The lock arrangement according to claim 3, wherein the movable arrangement comprises a pawl actuation lever for deflecting a pawl of the motor vehicle lock.

5. The lock arrangement according to claim 1, wherein the actuating arrangement comprises a door actuating lever of a door handle of the motor vehicle.

6. The lock arrangement according to claim 1, wherein the double action arrangement comprises two pivotable double action levers, wherein a first double action lever is a cable strand lever coupled to the cable strand and a second double action lever is a cable conduit lever coupled to the cable conduit.

7. The lock arrangement according to claim 6, wherein the double action levers are pivotable around a respective double action lever axis.

8. The lock arrangement according to claim 6, wherein the double action levers are mutually coupled such that a pivoting movement of either double action lever causes a proportional pivoting movement of the respective other double action lever in the opposite pivoting direction.

9. The lock arrangement according to claim 8, wherein, the double action levers are mutually coupled such that the relative movement between the cable strand and the cable conduit results in a predefined pivoting ratio between the double action levers.

10. The lock arrangement according to claim 6, wherein the double action levers are multi-armed levers comprising a respective cable arm, wherein the cable arm of the cable strand lever is coupled to the cable strand and the cable arm of the cable conduit lever is coupled to the cable conduit.

11. The lock arrangement of claim 10, wherein, the cable arms of the double action levers have substantially the same length.

12. The lock arrangement according to claim 10, wherein, the double action levers comprise a respective link arm, wherein the link arms of the double action levers are mutually coupled.

13. The lock arrangement according to claim 12, wherein, the link arms of the double action levers are of a respectively different length, so as to predefine the pivoting ratio between the double action levers.

14. The lock arrangement according to claim 6, wherein, the lock arrangement comprises a crash counter mass body for preventing the relative movement of the cable strand and the cable conduit in the case of a crash, which crash counter mass body is fixedly coupled with a crash mass lever of the double action levers.

15. The lock arrangement according to claim 14, wherein the actuating arrangement comprises a manual actuating lever fixedly connected to the double action lever distinct from the crash mass lever.

16. The lock arrangement according to claim 3, wherein the double action arrangement is arranged within the motor vehicle lock.

17. The lock arrangement according to claim 4, wherein the pawl actuation lever is configured to pivot around an actuation lever axis for deflecting the pawl of the motor vehicle lock.

18. The lock arrangement according to claim 7, wherein the double action lever axes of the double action levers define a line which is substantially parallel to a direction of relative movement between a respective coupling point of the cable strand and the cable conduit with the double action arrangement.

19. The lock arrangement of claim 10, wherein, the cable arms of the double action levers have substantially the same length, with respect to their respective double action lever axis.

20. The lock arrangement according to claim 12, wherein the links arms of the double action levers are mutually coupled so as to cause the proportional pivoting movement of the respective other double action lever in the opposite pivoting direction.
